(19) United States
(12) Patent Application Publication
(10) Pub. No.: US 2014/0339205 A1
(43) Pub. Date: Nov. 20, 2014

(54) VACUUM SEALING METHOD FOR HEAT INSULATING VESSEL

(71) Applicant: THERMOS (JIANGSU) HOUSEWARES CO., LTD., Jiangsu (CN)

(72) Inventors: Ronald Kwok Yo MAK, Jiangsu (CN); Tinghong CHEN, Jiangsu (CN)

(21) Appl. No.: 13/941,177

(22) Filed: Jul. 12, 2013

(30) Foreign Application Priority Data
May 14, 2013 (CN) 201310178963.6

(51) Int. Cl. B23K 26/24

(52) U.S. Cl. CPC B23K 26/24; B23K 2203/04
USPC 219/121.64

(57) ABSTRACT

A method for preparing a heat insulating vessel comprises: providing a container comprising an outer wall, an inner wall, an interlayer between the outer wall and the inner wall, and an orifice in the outer wall; covering the orifice with a sealing piece; evacuating air through the orifice so as to create a vacuum between the outer wall and the inner wall; and sealing the orifice with the sealing piece by laser welding to provide the heat insulating vessel.

The present application claims the priority from Chinese Patent Application No. 201310178963.6 titled “VACUUM SEALING METHOD FOR HEAT INSULATING VESSEL” and filed with the State Intellectual Property Office of China on May 14, 2013, the entire disclosure of which is incorporated herein by reference.

### FIELD OF THE DISCLOSURE

The present application relates to the technical field of producing a heat insulating vessel, and particularly to a vacuum sealing method for a heat insulating vessel.

### BACKGROUND

A heat insulating vessel is conventionally a container for holding water made of stainless steel or plastic along with a vacuum layer, with a cap being provided at the top of the heat insulating vessel to achieve a tight seal. The vacuum heat-isolating layer may retard the heat dissipation of the liquid such as water contained inside the vessel, so as to maintain the temperature of the liquid.

After the main body of the heat insulating vessel is produced, the heat insulating vessel is evacuated of air to create a vacuum, and then is sealed, thereby producing a vacuum heat-isolating layer of the heat insulating vessel.

In producing the main body of the heat insulating vessel, a preset orifice for evacuating the air in an interlayer of the heat insulating vessel may be preformed in an outer tube, an outer tube bottom or a metal bottom of the heat insulating vessel, and will be sealed after completion of the vacuum evacuation, so as to prevent air leakage.

A fused welding material is conventionally employed to seal the preformed orifice for vacuum evacuation in the prior art. However, welding materials generally contain substances harmful to human health, such as lead.

With the improvement of the living standards, an attention is increasingly paid to living environment, daily articles, foods and drinks which may affect human health, and requirements to those items are improved correspondingly.

Accordingly, there is an important technical problem to be addressed by the person skilled in the art to eliminate the substances harmful to human health contained in the heat insulating vessel caused by sealing the preformed orifice for vacuum evacuation with a welding material.

### SUMMARY

In one aspect, a method for preparing a heat insulating vessel, comprising: providing a container comprising an outer wall, an inner wall, an interlayer between the outer wall and the inner wall, and an orifice in the outer wall; covering the orifice with a sealing piece; evacuating air through the orifice so as to create a vacuum between the outer wall and the inner wall; and sealing the orifice with the sealing piece by laser welding to provide the heat insulating vessel.

In another aspect, a method for preparing a heat insulating vessel, comprising: providing a container comprising an outer wall, an inner wall, an interlayer between the outer wall and the inner wall, and an orifice in the outer wall; covering the orifice with a sealing piece; evacuating air through the orifice while heating the container so as to create a vacuum between the outer wall and the inner wall; and sealing the orifice with the sealing piece by laser welding to provide a heat insulating vessel.

In yet another aspect, a method for preparing a heat insulating vessel, comprising: providing a container comprising an outer wall, an inner wall, an interlayer between the outer wall and the inner wall, and an orifice in the outer wall; covering the orifice with a sealing piece; heating the container; evacuating air through the orifice so as to create a vacuum between the outer wall and the inner wall; and sealing the orifice with the sealing piece by laser welding to provide the heat insulating vessel.

The heat insulating vessel of this invention includes an outer wall, an inner wall and an interlayer between the outer wall and the inner wall, and the heat insulating vessel is preformed with an orifice at the outer wall for vacuum evacuation of the interlayer. The method for vacuum sealing a heat insulating vessel of this invention comprises: S01, covering said orifice with a sealing piece; S02, evacuating air from the interlayer through the orifice so as to create a vacuum; and S03, sealing the orifice with the sealing piece by laser welding.

According to another aspect of this invention, the heat insulating vessel includes an outer wall, an inner wall and an interlayer between the outer wall and the inner wall, and the heat insulating vessel is preformed with an orifice at the outer wall for vacuum evacuation of the interlayer; the method for vacuum sealing the heat insulating vessel comprises S01, covering the orifice with a sealing piece; S02, evacuating air from the interlayer of the heat insulating vessel through the orifice so as to create a vacuum while heating the heat insulating vessel; and S03, sealing the orifice with the sealing piece by laser welding. Heating the heat insulating vessel allows the temperature of the heat insulating vessel to rise, so that substances harmful to human body contained in the heat insulating vessel may volatilize.

### BRIEF DESCRIPTION OF THE DRAWINGS

In order to more clearly illustrate technical solutions in embodiments of the present application, drawings required for the description of the embodiments will be briefly introduced below. Apparently, the drawings described below are simply some embodiments of the present application, and those skilled in the art may also obtain other drawings, based on the following drawings, without any creative effort.

FIG. 1 is a schematic flow chart of a vacuum sealing method in a specific embodiment of the present application; and

FIG. 2 is a schematic structural view of a heat insulating vessel in a specific embodiment of the present application.

### DETAILED DESCRIPTION OF THE EXEMPLARY EMBODIMENTS

In the specific embodiment, there is provided a vacuum sealing method for a heat insulating vessel, which is capable of avoiding substances harmful to human health from being contained in the heat insulating vessel resulted from the sealing of a preformed orifice for vacuum evacuation.

The embodiments of the present application will be clearly and fully described below in conjunction with accompanying drawings in the embodiments of the present application. The described embodiments are only representative examples of, but not all, of the embodiments of the present application. All other embodiments obtained by those ordinary skilled in the art based on the embodiments of the present application without making any creative efforts fall within the scope of protection of the present application.

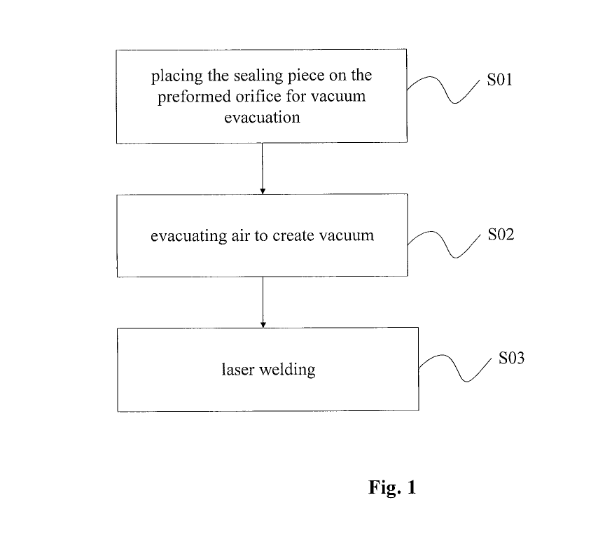

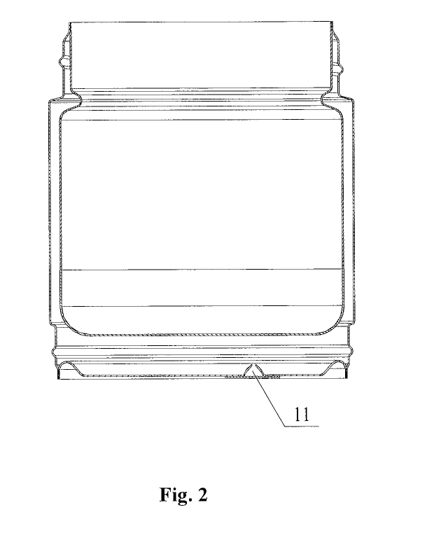

Referring to FIGS. 1 and 2, FIG. 1 is a schematic flow chart of a vacuum sealing method in a specific embodiment of the present application; and FIG. 2 is a schematic structural view of a heat insulating vessel in a specific embodiment of the present application. The heat insulating vessel in the specific embodiment of this application includes an outer wall, an inner wall and an interlayer formed between the outer wall and the inter wall. An orifice 11 is preformed at the outer wall for vacuum evacuating the interlayer.

A vacuum sealing method for a heat insulating vessel according to a specific embodiment includes:
S01, covering a preformed orifice for vacuum evacuation with a sealing piece;
S02, evacuating air from an interlayer of the heat insulating vessel through the preformed orifice for vacuum evacuation so as to create a vacuum; and
S03, sealing the preformed orifice for vacuum evacuation with the sealing piece by laser welding.

Thus, in the specific embodiment, the sealing piece is welded on the preformed orifice for vacuum evacuation by laser welding, and therefore vacuum sealing is achieved. The specific embodiment adopts laser welding process which requires no welding material, thereby avoiding substances harmful to human health from being contained in the heat insulating vessel resulted from the sealing of a preformed orifice for vacuum evacuation in the prior art.

Preferably, the preformed orifice for vacuum evacuation is tapered from outside to inside.

Preferably, the preformed orifice for vacuum evacuation is a circular orifice.

Preferably, after step S03, a step S04 is further included for heating the sealing piece.

Preferably, after step S01 and before step S02, a step S011 is further included for heating the heat insulating vessel.

Preferably, in step S02, while evacuating air from the interlayer of the heat insulating vessel to create the vacuum, the heat insulating vessel is heated, and after completion of the vacuum evacuation, temperature of the heat insulating vessel is maintained. Then, step S03 is performed.

Preferably, the heat insulating vessel is a stainless steel heat insulating vessel, and the sealing piece is a stainless steel sealing piece.

Preferably, the heat insulating vessel is a plastic heat insulating vessel, and the sealing piece is a plastic sealing piece.

Preferably, the diameter of a smaller opening end of the preformed orifice for vacuum evacuation is larger than 1 mm. The diameter of a lager opening end of the preformed orifice for vacuum evacuation is larger than 10 mm.

Preferably, the diameter of the circular orifice is larger than 10 mm.

The vacuum sealing method for the heat insulating vessel according to the present application includes steps of: S01, covering the preformed orifice for vacuum evacuation with the sealing piece; S02, evacuating air from an interlayer of the heat insulating vessel through the preformed orifice for vacuum evacuation so as to create a vacuum; and S03, sealing the preformed orifice for vacuum evacuation with the sealing piece by laser welding. Thus, the present application adopts laser welding process which requires no welding material, thereby avoiding substances harmful to human health from being otherwise contained in the heat insulating vessel resulted from the sealing of the preformed orifice for vacuum evacuation in the prior art.

Preferably, the temperature of the heat insulating vessel is maintained for a period of time before performing step S03, so as to enable the harmful substances to fully volatilize.

According to another aspect of this invention, the heat insulating vessel includes an outer wall, an inner wall and an interlayer between the outer wall and the inner wall, and the heat insulating vessel is preformed with an orifice at the outer wall for vacuum evacuation of the interlayer; the method for vacuum sealing the heat insulating vessel comprises, covering the orifice with a sealing piece; heating the heat insulating vessel to volatilize harmful substances; evacuating air from the interlayer of the heat insulating vessel through the orifice so as to create a vacuum; sealing the orifice with the sealing piece by laser welding.

Preferably, a further step of heating the sealing piece to activate a getter placed in the interlayer to absorb harmful gas is comprised.

Furthermore, when getter is placed in the vacuum interlayer of the heat insulating vessel according to the specific embodiment, preferably, after step S03, step S04 may further be included for heating the sealing piece. Heating the sealing piece may allow the temperature in the vacuum interlayer of the heat insulating vessel to rise, so as to activate the getter to absorb the harmful gas.

In a preferred solution of the present embodiment, in step S02, while evacuating air from the interlayer of the heat insulating vessel to create a vacuum, the heat insulating vessel is heated, and after the completion of vacuum evacuation, the temperature of the heat insulating vessel is maintained. Then, step S03 is performed.

Heating the heat insulating vessel allows the temperature of the heat insulating vessel to rise, so that substances harmful to human body contained in the heat insulating vessel may volatilize. Maintaining the temperature of the heat insulating vessel for a period of time may enable the harmful substances to fully volatilize. Then, the sealing piece may be sealed on the preformed orifice for vacuum evacuation by laser welding.

When vacuum evacuation is performed at the time of heating the heat insulating vessel, since the heating temperature generally is capable of reaching a temperature for activating the getter, there is no need for heating the sealing piece separately in this wall.

Of course, the heat insulating vessel may be evacuated firstly; after completion of the vacuum evacuation, the heat insulating vessel may be heated and insulated; and then laser welding process may be performed.

Alternatively, in an embodiment, the heat insulating vessel may be heated firstly as step S011, so that the harmful substances in the heat insulating vessel may volatilize, and then vacuum evacuation is performed. Since the heat insulating vessel has a good heat conductivity before being evacuated, even in wall of a relatively low heating temperature, the harmful substances may volatilize as well. As such, when the heat insulating vessel is heated, the temperature sufficient to activate the getter generally cannot be achieved. Therefore, after completion of the laser welding, the sealing piece is required to be heated further, so as to activate the getter.

Preferably, the heat insulating vessel is a stainless steel heat insulating vessel, and the sealing piece is a stainless steel sealing piece. The sealing material is a stainless steel plate which is of the same material as that of the stainless steel heat insulating vessel, and does not contain substances harmful to human health.

Of course, in a specific embodiment, the heat insulating vessel may also be a plastic heat insulating vessel, and the sealing piece may be a plastic sealing piece. The plastic heat insulating vessel is sealed with the plastic sealing piece by laser welding.

In a preferred solution of a specific embodiment, the preformed orifice 11 for vacuum evacuation is tapered from outside to inside. It is to be noted that, the above direction from outside to inside means the direction from the outside to the inside of the interlayer. In such an arrangement, the diameter of the outer end of the preformed orifice for vacuum evacuation is bigger, which may facilitate the vacuum evacuation equipment to perform the vacuum evacuation; and the diameter of the inner end of the preformed orifice for vacuum evacuation is smaller, which may improve the sealing effect after the preformed orifice 11 for vacuum evacuation is sealed.

It is to be noted that, for smooth vacuum evacuation of the interlayer, the diameter of the smaller opening end of the preformed orifice 11 for vacuum evacuation is bigger than 1 mm. And the lager opening end the performed orifice 11 may be larger than 10 mm.

Of course, the above preformed orifice for vacuum evacuation may also be a circular opening, a square opening or the like. The shape of the preformed orifice for vacuum evacuation is not specifically limited in the embodiment. When the preformed orifice for vacuum evacuation is a circular orifice, in order to reduce the resistance to the vacuum evacuation caused by the preformed orifice for vacuum evacuation, the diameter of the preformed orifice for vacuum evacuation may be larger than 10 mm.

Those skilled in the art can use or implement the present application based on the above description of the embodiments disclosed herein. Many modifications to these embodiments may be obvious to those skilled in the art. The general principle defined herein can be implemented in other embodiments without departing from the spirit or scope of the present application. Therefore, the present application will not be limited to these embodiments illustrated herein, but commensurate with the widest scope consistent with the principle and novel features disclosed herein.

1. A method for preparing a heat insulating vessel, comprising:
providing a container comprising an outer wall, an inner wall, an interlayer between the outer wall and the inner wall, and an orifice in the outer wall;
covering the orifice with a sealing piece;
evacuating air through the orifice so as to create a vacuum between the outer wall and the inner wall; and
sealing the orifice with the sealing piece by laser welding to provide the heat insulating vessel.

2. The method according to claim 1, wherein the orifice is tapered from outside the outer wall to inside the outer wall.

3. The method according to claim 1, wherein the orifice is a circular orifice.

4. The method according to claim 1, further comprising heating the sealing piece after sealing the orifice.

5. The method according to claim 1, further comprising heating the container after covering the orifice with the sealing piece and before evacuating air through the orifice.

6. The method according to claim 1, wherein in the step of evacuating air through the orifice, the container is heated, and after completion of the evacuating, the temperature of the container is maintained.

7. The method according to claim 1, wherein the heat insulating vessel is a stainless steel heat insulating vessel, and the sealing piece is a stainless steel sealing piece.

8. The method according to claim 1, wherein the heat insulating vessel is a plastic heat insulating vessel, and the sealing piece is a plastic sealing piece.

9. The method according to claim 2, wherein the diameter of a smaller opening end of the orifice is larger than 1 mm.

10. The method according to claim 3, wherein the diameter of the circular orifice is larger than 10 mm.

11. The method according to claim 9, wherein the diameter of a larger opening end of the circular orifice is larger than 10 mm.

12. The method according to claim 1, further comprising heating the container after evacuating air through the orifice.

13. A method for preparing a heat insulating vessel, comprising:
providing a container comprising an outer wall, an inner wall, an interlayer between the outer wall and the inner wall, and an orifice in the outer wall;
covering the orifice with a sealing piece;
evacuating air through the orifice while heating the container so as to create a vacuum between the outer wall and the inner wall; and
sealing the orifice with the sealing piece by laser welding to provide a heat insulating vessel.

14. The method according to claim 13, wherein the temperature of the container is maintained for a period of time before sealing the orifice.

15. The method according to claim 13, wherein the orifice is tapered from outside the outer wall to inside the outer wall.

16. The method according to claim 13, wherein the orifice is a circular orifice.

17. A method for preparing a heat insulating vessel, comprising:
providing a container comprising an outer wall, an inner wall, an interlayer between the outer wall and the inner wall, and an orifice in the outer wall;
covering the orifice with a sealing piece;
heating the container;
evacuating air through the orifice so as to create a vacuum between the outer wall and the inner wall; and
sealing the orifice with the sealing piece by laser welding to provide the heat insulating vessel.

18. The method according to claim 17, further comprising placing a getter in the interlayer and activating the getter.

19. The method according to claim 17, wherein the orifice is tapered from outside the outer wall to inside the outer wall.

20. The method according to claim 17, wherein the orifice is a circular orifice.
